(19) United States
(12) Patent Application Publication
(10) Pub. No.: US 2021/0143481 A1
(43) Pub. Date: May 13, 2021

(54) INORGANIC COATINGS IN SILICON-DOMINANT CELLS

(71) Applicant: ENEVATE CORPORATION, Irvine, CA (US)

(72) Inventors: Benjamin Park, Mission Viejo, CA (US); Sung Won Choi, Irvine, CA (US); Liwen Ji, Irvine, CA (US)

(21) Appl. No.: 16/681,583

(22) Filed: Nov. 12, 2019

(51) Int. Cl. H01M 10/0585; H01M 4/04; H01M 2/14; H01M 2/16; C09D 5/24

(52) U.S. Cl. CPC H01M 10/0585; H01M 4/0404; C09D 5/24; H01M 2/145; H01M 2/1646; H01M 4/0471

(57) ABSTRACT

Systems and methods are provided for using inorganic coatings in silicon-dominant cells.

### TECHNICAL FIELD

Aspects of the present disclosure relate to energy generation and storage. More specifically, certain implementations of the present disclosure relate to methods and systems for using inorganic coatings in silicon-dominant cells.

### BACKGROUND

Various issues may exist with conventional battery technologies. In this regard, conventional systems and methods, if any existed, for designing and making battery anodes may be costly, cumbersome, and/or inefficient—e.g., they may be complex and/or time consuming to implement, and may limit battery lifetime.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for using inorganic coatings in silicon-dominant cells, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1 is a diagram of a battery with silicon-dominant anode, in accordance with an example embodiment of the disclosure.

FIG. 2 illustrates an example silicon-dominant anode, in accordance with an example embodiment of the disclosure.

FIG. 3 is a flow diagram of a process for direct coating electrodes, in accordance with an example embodiment of the disclosure.

FIG. 4 is a flow diagram of an alternative process for transfer lamination of electrodes, in accordance with an example embodiment of the disclosure.

FIG. 5 is a diagram of a battery incorporating inorganic layers, in accordance with an example embodiment of the disclosure.

FIG. 6 illustrates an example apparatus for depositing inorganic layers on top of electrodes, in accordance with an example embodiment of the disclosure.

### DETAILED DESCRIPTION

FIG. 1 is a diagram of a battery with silicon-dominant anode, in accordance with an example embodiment of the disclosure. Referring to FIG. 1, there is shown a battery 100 comprising a separator 103 sandwiched between an anode 101 and a cathode 105, with current collectors 107A and 107B. There is also shown a load 109 coupled to the battery 100 illustrating instances when the battery 100 is in discharge mode. In this disclosure, the term “battery” may be used to indicate a single electrochemical cell, a plurality of electrochemical cells formed into a module, and/or a plurality of modules formed into a pack.

The development of portable electronic devices and electrification of transportation drive the need for high performance electrochemical energy storage. Small-scale (<100 Wh) to large-scale (>10 KWh) devices primarily use lithium-ion (Li-ion) batteries over other rechargeable battery chemistries due to their high-performance.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode are electrically coupled to the current collectors 107A and 1078, which comprise metal or other conductive material for providing electrical contact to the electrodes as well as physical support for the active material in forming electrodes.

The configuration shown in FIG. 1 illustrates the battery 100 in discharge mode, whereas in a charging configuration, the load 107 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. Sheets of the cathode, separator and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery 100 may comprise a solid, liquid, or gel electrolyte. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiAsF₆, LiPF₆, and LiCIO₄, lithium bis(trifluoromethanesulfonyl)imide (LiTFSI), lithium bis(fluorosulfonyl)imide (LiFSI), lithium difluoro(oxalate)borate (LiDFOB), lithium bis(oxalato)borate (LiBOB), and lithium triflate (LiCF₃SO₃), lithium tetrafluorooxalato phosphate (LTFOP), lithium difluorophosphate (LiPO₂F₂), lithium pentafluoroethyltrifluoroborate (LiFAB), and lithium 2-trifluoromethyl-4,5-dicyanoimidazole (LiTDI), lithium bis(2-fluoromalonato)borate (LiBFMB), lithium 4-pyridyl trimethyl borate (LPTB) and lithium 2-fluorophenol trimethyl borate (LFPTB), lithium catechol dimethyl borate (LiCDMB), etc. The separator 103 may be wet or soaked with a liquid or gel electrolyte. In addition, in an example embodiment, the separator 103 does not melt below about 100 to 120° C., and exhibits sufficient mechanical properties for battery applications. A battery, in operation, can experience expansion and contraction of the anode and/or the cathode. In an example embodiment, the separator 103 can expand and contract by at least about 5 to 10% without failing, and may also be flexible.

The separator 103 may be sufficiently porous so that ions can pass through the separator once wet with, for example, a liquid or gel electrolyte. Alternatively (or additionally), the separator may absorb the electrolyte through a gelling or other process even without significant porosity. The porosity of the separator 103 is also generally not too porous to allow the anode 101 and cathode 105 to transfer electrons through the separator 103.

The anode 101 and cathode 105 comprise electrodes for the battery 100, providing electrical connections to the device for transfer of electrical charge in charge and discharge states. The anode 101 may comprise silicon, carbon, or combinations of these materials, for example. Typical anode electrodes comprise a carbon material that includes a current collector such as a copper sheet. Carbon is often used because it has excellent electrochemical properties and is also electrically conductive. Anode electrodes currently used in rechargeable lithium-ion cells typically have a specific capacity of approximately 200 milliamp hours per gram. Graphite, the active material used in most lithium ion battery anodes, has a theoretical energy density of 372 milliamp hours per gram (mAh/g). In comparison, silicon has a high theoretical capacity of 4200 mAh/g (at high temperature, the value is about 3579 mAh/g at room temperature). In order to increase volumetric and gravimetric energy density of lithium-ion batteries, silicon may be used as the active material for the cathode or anode. Silicon anodes may be formed from silicon composites, with more than 50% silicon, for example.

In an example scenario, the anode 101 and cathode 105 store the ion used for separation of charge, such as lithium. In this example, the electrolyte carries positively charged lithium ions from the anode 101 to the cathode 105 in discharge mode, as shown in FIG. 1 for example, and vice versa through the separator 105 in charge mode. The movement of the lithium ions creates free electrons in the anode 101 which creates a charge at the positive current collector 1078. The electrical current then flows from the current collector through the load 109 to the negative current collector 107A. The separator 103 blocks the flow of electrons inside the battery 100, allows the flow of lithium ions, and prevents direct contact between the electrodes.

While the battery 100 is discharging and providing an electric current, the anode 101 releases lithium ions to the cathode 105 via the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current Li-ion batteries need to be improved in order to, for example, compete with internal combustion engine (ICE) technology and allow for the widespread adoption of electric vehicles (EVs). High energy density, high power density, and improved safety of lithium-ion batteries are achieved with the development of high-capacity and high-voltage cathodes, high-capacity anodes and functionally non-flammable electrolytes with high voltage stability and interfacial compatibility with electrodes. In addition, materials with low toxicity are beneficial as battery materials to reduce process cost and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be manipulated by incorporating conductive additives with different morphological properties. Carbon black (Super P), vapor grown carbon fibers (VGCF), graphite and a mixture of them have previously been incorporated separately into the anode electrode resulting in improved performance of the anode. The synergistic interactions between the two carbon materials may facilitate electrical contact throughout the large volume changes of the silicon anode during charge and discharge.

State-of-the-art lithium-ion batteries typically employ a graphite-dominant anode as an intercalation material for lithium. Silicon-dominant anodes, however, offer improvements compared to graphite-dominant Li-ion batteries. Silicon exhibits both higher gravimetric (3579 mAh/g vs. 372 mAh/g for graphite) and volumetric capacities (2194 mAh/L vs. 890 mAh/L for graphite). In addition, silicon-based anodes have a lithiation/delithiation voltage plateau at about 0.3-0.4V vs. Li/Li⁺, which allows it to maintain an open circuit potential that avoids undesirable Li plating and dendrite formation. While silicon shows excellent electrochemical activity, achieving a stable cycle life for silicon-based anodes is challenging due to silicon's large volume changes during lithiation and delithiation. Silicon regions may lose electrical contact from the anode as large volume changes coupled with its low electrical conductivity separate the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life.

Use of silicon may also add some complexities to the forming processes. For example, in many instances, silicon-dominant electrodes may go through expansion and shrinking during electrode processing. This is described in more detail with respect to FIG. 2. Such expansion, if not accounted for and/or mitigated, may affect other components of the battery. For example, expansion and shrinking of the silicon-dominant anode may be damage the separator, if no remedial measures are taken.

Thus, implementations according to the present disclosure may incorporate such remedial measures, particularly by use of inorganic (or substantially inorganic) layers that are applied on top of silicon-dominant electrodes (e.g., either on the electrodes themselves, on or corresponding surfaces in adjacent components abutting the electrodes), to protect other components of the battery (e.g., the separator, other electrode, etc.) during electrode processing, as well as during battery forming and operation in general. This is described further with respect to FIGS. 5-6.

FIG. 2 illustrates an example silicon-dominant anode, in accordance with an example embodiment of the disclosure. Referring to FIG. 2, there are shown a current collector 201, an optional adhesive 203, and an active material 205. It should be noted, however, that the adhesive 203 may or may not be present depending on the type of anode fabrication process utilized, as the adhesive is not necessarily there in a direct coating process where the active material is formed directly on the current collector.

In an example scenario, the active material 205 comprises silicon particles in a binder material and a solvent, the active material 205 being pyrolyzed to turn the binder into a glassy carbon that provides a structural framework around the silicon particles and also provides electrical conductivity. The active material may be coupled to the current collector 201 using the optional adhesive 203. The current collector 201 may comprise a metal film, such as copper, nickel, or titanium, for example, although other conductive foils may be utilized depending on desired tensile strength.

FIG. 2 also illustrates lithium particles impinging upon and lithiating the active material 205. The lithiation of silicon-dominant anodes causes expansion of the material, where horizontal expansion is represented by the x and y axes, and thickness expansion is represented by the z-axis, as shown. The current collector 201 has a thickness t, where a thicker foil provides greater strength and providing the adhesive 203 is strong enough, restricts expansion in the x- and y-directions, resulting in greater z-direction expansion, thus anisotropic expansion. Example thicker foils may be greater than 6 μm, such as 10 μm or 20 μm for copper, for example, while thinner foils may be less than 6 μm thick in copper.

In another example scenario, when the current collector 201 is thinner, on the order of 5-6 μm for a copper foil, for example, the active material 205 may expand more easily in the x- and y-directions, although still even more easily in the z-direction without other restrictions in that direction. In this case, the expansion is anisotropic, but not as much as compared to the case of higher x-y confinement.

In addition, different materials with different tensile strength may be utilized to configure the amount of expansion allowed in the x- and y-directions. For example, nickel is a more rigid, mechanically strong metal for the current collector 201, and as a result, nickel current collectors confine x-y expansion when a strong enough adhesive is used. In this case, the expansion in the x- and y-directions may be more limited, even when compared to a thicker copper foil, and result in more z-direction expansion, i.e., more anisotropic. In anodes formed with 5 μm nickel foil current collectors, very low expansion and no cracking results. Furthermore, different alloys of metals may be utilized to obtain desired thermal conductivity, electrical conductivity, and tensile strength, for example.

In an example scenario, when an adhesive is used, the adhesive 203 comprises a polymer such as polyimide (PI) or polyamide-imide (PAI) that provides adhesive strength of the active material film 205 to the current collector 201 while still providing electrical contact to the current collector 201. Other adhesives may be utilized depending on the desired strength, as long as they can provide adhesive strength with sufficient conductivity following processing. If the adhesive 203 provides a stronger, more rigid bond, the expansion in the x- and y-directions may be more restricted, assuming the current collector is also strong. Conversely, a more flexible and/or thicker adhesive may allow more x-y expansion, reducing the anisotropic nature of the anode expansion.

As noted above, use of silicon may create unique conditions that may require remedial measures. For example, the reduction reactions that may occur at the anode may adversely affect other components (such as the cathode). Also, the expansion (and shrinking) of silicon (e.g., in silicon-dominant anodes) may affect other components (e.g., the separator) if not accounted for and/or mitigated, may affect other components of the battery. Thus, implementations according to the present disclosure may incorporate remedial measures for accounting for and mitigating the effects of use of silicon in the anode, particularly by use of inorganic (or substantially inorganic) layers that are applied between the silicon-dominant electrode and the separator (e.g., on top of the silicon-dominant electrode itself, as separate layer, or onto the side of the separator facing the silicon-dominant electrode), to protect other components of the cell (e.g., the separator and/or the cathode) during electrode processing (and battery forming in general). This is described further with respect to FIGS. 5-6.

FIG. 3 is a flow diagram of a process for direct coating electrodes, in accordance with an example embodiment of the disclosure. This process comprises physically mixing the active material, conductive additive, and binder together, and coating it directly on a current collector. This example process comprises a direct coating process in which an anode slurry is directly coated on a copper foil using a binder such as PVDF, CMC, SBR, Sodium Alginate, PAI, Poly(acrylic acid) (FAA, PI, LA133, polyvinyl alcohol (PVA), polyethylene glycol (PEG), Nafion solution, recently reported electronically conductive polymer binders, and mixtures and combinations thereof. Another example process comprising forming the active material on a substrate and then transferring to the current collector is described with respect to FIG. 4.

In step 301, the raw electrode active material may be mixed using a binder/resin (such as PI, PAI), solvent, and conductive carbon, such as Super P, graphene, VGCF, graphite, or other types of hard/soft carbon, etc., or a combination therefore. For example, graphene/VGCF (1:1 by weight) may be dispersed in NMP under sonication for, e.g., 1 hour followed by the addition of Super P (1:1:1 with VGCF and graphene) and additional sonication for, e.g., 45-75 minutes. Silicon powder with a desired particle size, may then be dispersed in polyamic acid resin (15% solids in N-Methyl pyrrolidone (NMP)) at, e.g., 1000 rpm in a ball miller for a designated time, and then the conjugated carbon/NMP slurry may be added and dispersed at, e.g., 2000 rpm for, e.g., another predefined time to achieve a slurry viscosity within 2000-4000 cP and a total solid content of about 30%. The particle size and mixing times may be varied to configure the active material density and/or roughness.

In step 303, the slurry may be coated on the foil at a loading of, e.g., 3-4 mg/cm², which may undergo drying in step 305 resulting in less than 15% residual solvent content. In step 307, an optional calendering process may be utilized where a series of hard pressure rollers may be used to finish the film/substrate into a smoother and denser sheet of material.

In step 309, the active material may be pyrolyzed by heating to 500-800° C. such that carbon precursors are partially or completely converted into glassy carbon. The pyrolysis step may result in an anode active material having silicon content greater than or equal to 50% by weight, where the anode has been subjected to heating at or above 400 degrees Celsius. Pyrolysis can be done either in roll form or after punching in step 311. If done in roll form, the punching is done after the pyrolysis process. The punched electrode may then be sandwiched with a separator and cathode with electrolyte to form a cell.

In step 313, the cell may be subjected to a formation process, comprising initial charge and discharge steps to lithiate the anode, with some residual lithium remaining.

FIG. 4 is a flow diagram of an alternative process for transfer lamination of electrodes, in accordance with an example embodiment of the disclosure. While the previous process to fabricate composite anodes employs a direct coating process, this process physically mixes the active material, conductive additive, and binder together coupled with peeling and lamination processes.

This process is shown in the flow diagram of FIG. 4, starting with step 401 where the active material may be mixed with a binder/resin such as polyimide (PI) or polyamide-imide (PAI), solvent, other additives, and optionally a conductive carbon, such as Super P, graphene, VGCF, graphite, or other types of hard/soft carbon, etc., or a combination therefore. As with the process described in FIG. 4, graphene/VGCF (1:1 by weight) may be dispersed in NMP under sonication for, e.g., 45-75 minutes followed by the addition of Super P (1:1:1 with VGCF and graphene) and additional sonication for, e.g., 1 hour. Silicon powder with a desired particle size, may then be dispersed in polyamic acid resin (10-20% solids in N-Methyl pyrrolidone (NMP)) at, e.g., 800-1200 rpm in a ball miller for a designated time, and then the conjugated carbon/NM P slurry may be added and dispersed at, e.g., 1800-2200 rpm for, e.g., another predefined time to achieve a slurry viscosity within 2000-4000 cP and a total solid content of about 30%. The particle size and mixing times may be varied to configure the active material density and/or roughness.

In step 403, the slurry may be coated on a polymer substrate, such as polyethylene terephthalate (PET), polypropylene (PP), or Mylar. The slurry may be coated on the PET/PP/Mylar film at a loading of 3-4 mg/cm² (with 15% solvent content), and then dried to remove a portion of the solvent in step 405. An optional calendering process may be utilized where a series of hard pressure rollers may be used to finish the film/substrate into a smoothed and denser sheet of material.

In step 407, the green film may then be removed from the PET, where the active material may be peeled off the polymer substrate, the peeling process being optional for a polypropylene (PP) substrate, since PP can leave ˜2% char residue upon pyrolysis. The peeling may be followed by a cure and pyrolysis step 409 where the film may be cut into sheets, and vacuum dried using a two-stage process (100-140° C. for 15 h, 200-240° C. for 5 h). The dry film may be thermally treated at 1000-1300° C. to convert the polymer matrix into carbon. The pyrolysis step may result in an anode active material having silicon content greater than or equal to 50% by weight, where the anode has been subjected to heating at or above 400 degrees Celsius.

In step 411, the pyrolyzed material may be flat press or roll press laminated on the current collector, where a copper foil may be coated with polyamide-imide with a nominal loading of 0.35-0.75 mg/cm² (applied as a 5-7 wt % varnish in NMP, dried 10-20 hour at 100-140° C. under vacuum). In flat press lamination, the silicon-carbon composite film may be laminated to the coated copper using a heated hydraulic press (30-70 seconds, 250-350° C., and 3000-5000 psi), thereby forming the finished silicon-composite electrode. In another embodiment, the pyrolyzed material may be roll-press laminated to the current collector.

In step 413, the electrode may then be sandwiched with a separator and cathode with electrolyte to form a cell. The cell may be subjected to a formation process, comprising initial charge and discharge steps to lithiate the anode, with some residual lithium remaining. The expansion of the anode may be measured to confirm reduced expansion and anisotropic nature of the expansion. The larger silicon particle size results in a rougher surface, higher porosity and less dense material, which reduces the expansion of the active material during lithiation.

FIG. 5 is a diagram of a battery incorporating inorganic layers, in accordance with an example embodiment of the disclosure. Referring to FIG. 5, there is shown a battery 500 comprising an anode current collector 501, an anode 503 a separator 505, a cathode 507, and a cathode current collector 509. The battery 500 (and components thereof) may be similar to the battery 100 (and similarly named components thereof), as described with respect to FIG. 1. However, the battery 500 additionally incorporates inorganic layers, shown as inorganic layers 511 and 513 in FIG. 5, between one or both of the electrodes of the battery 500—that is, the anode 503 and/or the cathode 507, and the adjacent component—that is, the separator 505. In other words, each of the inorganic layers 511 and 513 may be placed between one of anode 503 and the cathode 507, and the separator 505.

As used herein, “inorganic layer” (or “inorganic coating”) refers to a layer or coating comprised completely or substantially of inorganic material or compounds. Use of such inorganic layer or coating may be advantageous, particularly in silicon-dominant environment. The inorganic layer or coating may be applied directly to the electrode (particularly the silicon-dominant anodes). In such implementations, the inorganic coatings are deposited or applied directly on, and adhere to the electrodes (particularly the anode) as opposed to the separator. However, in some instances, inorganic layer(s) or coating(s) may be applied to the separator. Such inorganic layer(s) or coating(s) may be different than any existing separator coatings in that they are specifically configured for use in conjunction with silicon-dominant electrodes and/or for accounting for and mitigating conditions that arise from use of silicon in such electrodes.

As noted above, use of such inorganic layers or coatings (e.g., applied on top of electrodes) may have many advantages, particularly in a silicon-dominant environment. For example, applying such inorganic coatings in silicon-dominant anodes) protects adjacent components (namely the separator) during processing of the electrode—e.g., from reduction reactions taking place in the anode. Thus, the use of the inorganic coatings protects the other components of the cell from detrimental reactions relating to the reduction taking place in the anode. Relatedly, the inorganic layers or coatings between the silicon-dominant anode and the separator reinforces the separator and may be function as back-up to it—e.g., as the inorganic layers or coatings may be configured to perform some of the functions the separator performs (e.g., protection and separation between the anode and cathode during reduction/oxidation), thus be available to continue providing such protective functions even when/if the separator failed.

The inorganic layers or coatings may also provide physical protection from potential damage caused by changes in the anode—that is, the inorganic layer may also act as mechanical buffer (e.g., for stress, etc.). In this regard, once applied the inorganic coating acts as a mechanical buffer that assists with creating a boundary layer between the separator and the silicon within the anode so that, mechanically, the layer absorbs some of the expansion and contraction strain within the system. In particular, the layer isolates the separator from the shrinking and expansion that silicon goes through during the reduction reactions (e.g., the heating process). Such isolation prevents stresses caused by the expansion/shrinking of silicon from reaching the separator. This may be because inorganic material wets better than organic material, and as such can absorb the stresses of the silicon's expansion/shrinking.

Further, the inorganic layer may also act as a scavenger for detrimental chemicals, particularly based on the inorganic material used. In this regard, many inorganic material or compounds (e.g., metal oxides) may be excellent scavengers, thus when included in the inorganic layer may allow the layer to act as a scavenger for such detrimental chemicals as H₂O or HF.

The inorganic layer/coating may also assist with the wetting of electrolyte within the cell/battery. In this regard, as noted inorganic material has better wetting characteristics than organic material (e.g., polyethylene polypropylene, polyethylene, etc.), which do not wet as well. Thus, having the inorganic layer adjacent to the separator may enhancing wetting of electrolyte onto the electrodes.

Thus, use of such inorganic layers/coating on top of electrodes (particularly silicon-dominant anodes) may enable significant improvement of separators (and obviate the need for using coated separators).

With respect to the composition of the inorganic layer/coating, various inorganic material and/or compounds may be used. In this regard, the selection of material (and precise amounts/percentages in the layer) may be adaptively determined (e.g., experimentally), such as based on desired functions and/or characteristics of the battery (or components thereof).

For example, in various implementations, the inorganic coatings may comprise ceramic materials, which may be particularly suitable for the protective and/or buffering functions—e.g., maintaining separation if silicon expands and/or separator shrinks. The inorganic coatings may also comprise metal oxide materials, which as noted above may particularly be suitable for enhanced wetting (which improves electrolyte wetting onto the electrodes). Such material also has higher surface energy.

Example inorganic materials that may be used in the inorganic layers/coating applied to the electrodes may include binary oxides, such as SiO₂, Al₂O₃, ZnO, MgO, TiO₂, ZrO₂, ternary oxide of BaTiO₃ (BTO), y-LiAlO₂, zeolite; metal carbonate, such as CaCO₃, metal hydroxides, such as Al(OH)₃, Mg(OH)₂, quaternary oxides (may also be ceramic electrolytes) of Li₇La₃Zr₂O₁₂ (LLZO), Li_{0.33}La_{0.56}TiO₃ (lanthanum lithium titanate (LLTO)), ceramic electrolyte lithium aluminum germanium phosphate (LAGP), and the like. Further, besides the aforementioned oxides and carbonates, nitrides or carbides of Si, Al, Zr, Sn, Ce or Y such as SiC may also be used. In addition, metal halogens, such as AlF₃, AlI₃, LiF, Lil, etc. may be used in some implementations.

While the inorganic layers/coating typically may be made up completely of inorganic material and/or compounds, the disclosure is not limited as such, and in some implementations, the inorganic layers/coating may be made up substantially from inorganic material and/or compounds—that is, may contain some organic (or carbon forming) material. For example, in some implementations, the inorganic layers/coating may be formed from slurry that contains material (e.g., precursor binder) that converts to carbon. Nonetheless, if the amount of organic (or carbon) is sufficiently small (e.g., <5% by weight) the layer remains substantially inorganic, and may operate substantially in similar manner, with respect to the intended functions thereof, as completely inorganic layers or coatings.

Various techniques and/or processes may be used for applying the inorganic layer/coating to the electrodes. For example, the inorganic layer may be deposited using suitable techniques, such as atomic layer deposition (ALD), chemical vapor deposition (CVD), physical vapor deposition (PVD). In some implementations, the inorganic layer is coated onto the electrode after the electrode is made (i.e., after the heat-treatment for forming the anode or cathode). The inorganic layer may be applied, for example, as a protective film onto the electrode or sprayed onto the electrode—that is, using spray coating onto the electrode.

In some implementations, the inorganic layer may be applied before or as part of the process for forming the electrode. For example, the inorganic layer/coating may be fabricated with the anode—e.g., being formed during the same heat-treatment process used in forming the silicon-dominant anode (a process in which polymer is converted into carbon). For example, the inorganic layer may be formed from a slurry that is processed to form the inorganic layer.

In some instances, different temperature ranges may be supported in different implementations, such as based on the composition of the inorganic layer used. For example, in some implementations, the heat-treatment may be configured for >300° C. In other implementations, the heat-treatment may be configured for >400° C. In other implementations, the heat-treatment may be configured for >500° C. Thus, where the temperature requirements may be irreconcilable (e.g., where the maximum temperature that may be used, based on the composition of the inorganic material is below the temperature needed for the heat-treatment of the electrode), separate heat-treatments may be used for the electrode and the inorganic layer.

In some implementations, the inorganic layer may be applied to other components (rather than the silicon-dominant anode—e.g., to the separator (the side facing the anode, or both sides), or the top cathode). For example, inorganic layer may be coated on the separator, being applied as a protective film onto the separator or sprayed onto the separator—that is, using spray coating onto the separator.

In some implementations, the forming of the inorganic layer may be done (based on the implementation) as part of the electrode forming, or may be done after the electrode forming. For example, the inorganic layer may be fabricated with a slurry that is pyrolyzed to make the layer in the same heat-treatment process as that used to make the electrode. This may be done for both the anode and the cathode. In either case, a pyrolyzed electrode (anode or cathode) is formed, having an active material film and an inorganic layer/coating on top created in the same pyrolysis process. In some instances, the inorganic layer slurry may contain precursor materials, which may facilitate the forming during the pyrolysis. In this regard, the precursor binder holds the inorganic material on top of the electrode active material layer. The selection of the precursor binder used in the slurry may be based on various considerations.

For example, in some instances a precursor binder that would be non-conductive even after pyrolysis may be selected. In this regard, a precursor that does not convert to carbon may be used in the inorganic layer slurry. An example of such precursor binder is polydimethylsiloxane (PDMS), which when used results in material similar to SiOₓ material, thus making it particularly suitable for use with silicon-dominant anodes. In some instances, however, the inorganic slurry may include precursor that converts to carbon—e.g., same polymer/precursor binder used in the electrode slurry, which may be a carbon-source polymer such as polyimide (PI), polyamide-imide (PAI), etc. In this regard, as noted above, using such a carbon forming material may be fine as long as it yields a sufficiently small amount of carbon that the layer remains substantially inorganic.

Use of a precursor (or binder) is not necessary, however, and in some instances no precursor binder is used. Rather, the inorganic material may be kept together using surface forces. Thus, based on the implementation, the inorganic layer slurry may contain a carbon forming (or carbon source) precursor binder, non-carbon forming precursor binder, or no precursor binder.

In some implementations, the inorganic layer slurry may be laid on top of the anode slurry (as a second slurry). In some implementations, however, the inorganic layer slurry may be laid concurrently with the electrode slurry—e.g., being co-extruded with the electrode slurry, using suitable apparatus. In other words, rather than coating the inorganic material onto the anode (after processing), material forming the inorganic layer may be used, being included in the slurry used in making the anode—so, the slurry would have two parts, a first part containing the anode active material and polymer (forming the active material) and a second part forming the inorganic layer on top. An example implementation of such apparatus is shown in and described with respect to FIG. 6.

As the inorganic layer/coating is typically tailored for mitigating effects of silicon, it is typically used on and applied to only the silicon-dominant anode. However, in some instances, an inorganic layer/coating may be applied on both of the anodes and the cathode. In such implementations, inorganic layers/coatings may be applied to the “top” surfaces of both of the anode and cathode (that is the surfaces opposite of the surfaces in contact with the corresponding current collectors), as shown in FIG. 5.

In an example implementation, inorganic layers/coatings may combine to provide the “separator” function in the cell—that is, allowing for elimination of a separate separator component. For example, one or both of the anode and the cathode may have ignorance layer coated thereon (after pyrolysis, or included as slurry that is subject to the pyrolysis process applied to the electrode(s)), which may be configured to perform the separator's functions in the formed cell/battery, such that the separator may be eliminated.

FIG. 6 illustrates an example apparatus for depositing inorganic layers on top of electrodes, in accordance with an example embodiment of the disclosure. Shown in FIG. 6 is an apparatus 600 that may be used in depositing inorganic layers on top of electrodes.

The apparatus 600 may be configured for creating an electrode slurry 611, containing the anode active material and polymer (forming the active material), and an inorganic slurry 621, containing material, laid on top of the electrode slurry 611, for forming an inorganic layer/coating on top of the electrode (e.g., silicon-dominant anode). For example, the apparatus 600 may comprise an electrode slurry depositor 610, configured for depositing the electrode slurry 611 (e.g., coating it on top of a foil or adhesive sheet), and an inorganic slurry depositor 620 configured for depositing the inorganic slurry 621, on top of the electrode slurry 611.

As illustrated in FIG. 6, the apparatus 600 may be configured for creating a two-part slurry, comprising the electrode slurry 611 on the bottom and the inorganic slurry 621 on top. In this regard, the electrode slurry depositor 610 and the inorganic slurry depositor 620 may be arranged for creating the two-part slurry via co-extruding, such as by arranging the electrode slurry depositor 610 and the inorganic slurry depositor 620 in the manner shown in FIG. 6.

An example method of forming a battery, in accordance with the present disclosure, comprises applying a substantially inorganic layer between an electrode of the battery and an adjacent component of the battery, where forming the electrode comprises heat-treatment of the electrode.

In an example embodiment, the substantially inorganic layer is formed during the heat-treatment of the electrode.

In an example embodiment, the substantially inorganic layer is applied before or after the heat-treatment of the electrode.

In an example embodiment, applying the substantially inorganic layer comprises spraying the substantially inorganic layer or a substantially inorganic layer precursor.

In an example embodiment, applying the substantially inorganic layer comprises applying a protective film comprising the substantially inorganic layer or a substantially inorganic layer precursor.

In an example embodiment, forming of the electrode comprises coating an electrode slurry on a substrate or a metal foil, and a substantially inorganic layer precursor is applied after the coating of the electrode slurry. The substantially inorganic layer precursor is configured for forming substantially inorganic layer.

In an example embodiment, applying the substantially inorganic layer comprises applying an inorganic layer slurry onto a top of an electrode slurry, and forming the electrode comprises applying pyrolysis to both of the inorganic layer slurry and the electrode slurry.

In an example embodiment, the inorganic layer slurry and the electrode slurry are coextruded onto a substrate or a metal foil.

In an example embodiment, the inorganic layer slurry comprises a carbon forming precursor binder, non-carbon forming precursor binder, or no precursor binder.

In an example embodiment, the inorganic layer slurry comprises a nonconductive-carbon forming precursor binder.

In an example embodiment, the substantially inorganic layer comprises one or more of metal oxides, metal carbonates, metal hydroxides, ceramic electrolytes, metal nitrides, metal carbides, and metal halogens.

In an example embodiment, the battery comprises a separator that abuts the electrode; and wherein the substantially inorganic layer is applied to one or both of the electrode and the separator.

In an example embodiment, a second substantially inorganic layer is applied to a second electrode of the battery, with the substantially inorganic layer and the second substantially inorganic layer being configured to function together as a separator in the battery.

In an example embodiment, at least one of the electrode or the second electrode of the battery comprises a silicon-dominant electrode, and the substantially inorganic layer is configured to account for and/or mitigate effects use of silicon in the battery.

An example apparatus for forming a battery, in accordance with the present disclosure, comprises a depositor configured for applying a substantially inorganic layer to a top surface of an electrode, with the forming of the electrode comprising heat-treatment of the electrode.

In an example embodiment, the apparatus is configured to form the substantially inorganic layer during the heat-treatment of the electrode.

In an example embodiment, the depositor is configured to apply the substantially inorganic layer before or after the heat-treatment of the electrode.

In an example embodiment, the depositor is configured to spray the substantially inorganic layer on the electrode.

In an example embodiment, the depositor is configured to apply a protective film comprising the substantially inorganic layer or substantially inorganic layer precursor onto the electrode.

In an example embodiment, the depositor is configured to coextrude an inorganic layer slurry that comprises substantially inorganic material and an electrode slurry that comprises electrode active material onto a substrate or a metal foil.

An example inorganic slurry for use in forming a battery, in accordance with the present disclosure, comprises inorganic material, the inorganic material comprising one or more of metal oxides, metal carbonates, metal hydroxides, ceramic electrolytes, metal nitrides, metal carbides, and metal halogens, with the inorganic slurry configured for creating a substantially inorganic layer on top of an electrode of the battery, for additional safety and performance during the operation of the battery.

In an example embodiment, the inorganic slurry comprises a carbon forming precursor binder.

In an example embodiment, the inorganic slurry comprises a non-conductive-carbon forming precursor binder.

In an example embodiment, the ceramic electrolytes comprise one or more of Li₇La₃Zr₂O₁₂ (LLZO), Li_{0.33}La_{0.56}TiO₃ (LLTO), and lithium aluminum germanium phosphate (LAGP)

In an example embodiment, the metal oxides comprise one or more of SiO₂, Al₂O₃, MgO, ZrO₂, TiO₂, ZnO, BaTiO₃ (BTO), y-LiAlO₂.

In an example embodiment, the metal hydroxides comprise one or more of Al(OH)₃ and Mg(OH)₂.

In an example embodiment, the metal carbonates comprise CaCO₃.

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

As utilized herein, an apparatus is “configurable” to perform a function whenever the apparatus comprises the necessary hardware and code (if any is necessary) to perform the function, regardless of whether performance of the function is disabled or not enabled (e.g., by a user-configurable setting, factory trim, etc.).

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method of forming a battery, the method comprising:
applying a substantially inorganic layer between an electrode of the battery and an adjacent component of the battery, wherein:
forming of the electrode comprises heat-treatment of the electrode, and
at least a portion of the substantially inorganic layer is formed during the heat-treatment of the electrode.

2. (canceled)

3. The method of claim 1, comprising applying at least a portion of the substantially inorganic layer before or after the heat-treatment of the electrode.

4. The method of claim 1, wherein applying the substantially inorganic layer comprises spraying the substantially inorganic layer or a substantially inorganic layer precursor.

5. The method of claim 1, wherein applying the substantially inorganic layer comprises applying a protective film comprising the substantially inorganic layer or a substantially inorganic layer precursor.

6. The method of claim 1, wherein forming of the electrode comprises coating an electrode slurry on a substrate or a metal foil; and further comprising applying a substantially inorganic layer precursor after the coating of the electrode slurry.

7. The method of claim 1, wherein applying the substantially inorganic layer comprises applying an inorganic layer slurry onto a top of an electrode slurry; and
wherein forming of the electrode comprises applying pyrolysis to both of the inorganic layer slurry and the electrode slurry.

8. The method of claim 7, comprising coextruding the inorganic layer slurry and the electrode slurry onto a substrate or a metal foil.

9. The method of claim 7, wherein the inorganic layer slurry comprises a carbon forming precursor binder, non-carbon forming precursor binder, or no precursor binder.

10. The method of claim 7, wherein the inorganic layer slurry comprises a nonconductive-carbon forming precursor binder.

11. The method of claim 1, wherein the substantially inorganic layer comprises one or more of metal oxides, metal carbonates, metal hydroxides, ceramic electrolytes, metal nitrides, metal carbides, and metal halogens.

12. The method of claim 1, wherein the battery comprises a separator that abuts the electrode; and wherein the substantially inorganic layer is applied to one or both of the electrode and the separator.

13. The method of claim 1, wherein the substantially inorganic layer is configured to function as a separator in the battery.

14. The method of claim 1, comprising applying a second substantially inorganic layer to a second electrode of the battery; wherein one or both of the substantially inorganic layer and the second substantially inorganic layer are configured to function together as a separator in the battery.

15. The method of claim 1, wherein at least one of the electrode or a second electrode of the battery comprises a silicon-based electrode; and wherein the substantially inorganic layer is configured to account for and/or mitigate effects use of silicon in the battery.

16. An apparatus for use in forming a battery, the apparatus comprising:
a depositor configured for applying a substantially inorganic layer to a top surface of an electrode, wherein forming of the electrode comprises heat-treatment of the electrode.

17. The apparatus of claim 16, wherein the apparatus is configured to form the substantially inorganic layer during the heat-treatment of the electrode.

18. The apparatus of claim 16, wherein the depositor is configured to apply the substantially inorganic layer before or after the heat-treatment of the electrode.

19. The apparatus of claim 16, wherein the depositor is configured to spray the substantially inorganic layer on the electrode.

20. The apparatus of claim 16, wherein the depositor is configured to apply a protective film comprising the substantially inorganic layer or substantially inorganic layer precursor onto the electrode.

21. The apparatus of claim 16, wherein the depositor is configured to coextrude an inorganic layer slurry that comprises substantially inorganic material and an electrode slurry that comprises electrode active material onto a substrate or a metal foil.

22. An inorganic slurry for use in forming a battery, the slurry comprising:
inorganic material, the inorganic material comprising one or more of metal oxides, metal carbonates, metal hydroxides, ceramic electrolytes, metal nitrides, metal carbides, and metal halogens;
wherein the inorganic slurry is configured for creating a substantially inorganic layer on top of an electrode of the battery, for additional safety and performance during the operation of the battery.

23. The inorganic slurry of claim 22, comprising a carbon forming precursor binder.

24. The inorganic slurry of claim 22, comprising a non-conductive-carbon forming precursor binder.

25. The inorganic slurry of claim 22, wherein the ceramic electrolytes comprise one or more of Li₇La₃Zr₂O₁₂ (LLZO), Li_{0.33}La_{0.56}TiO₃ (LLTO), and lithium aluminum germanium phosphate (LAGP)

26. The inorganic slurry of claim 22, wherein the metal oxides comprise one or more of SiO₂, Al₂O₃, MgO, ZrO₂, TiO₂, ZnO, BaTiO₃ (BTO), y-LiAlO₂.

27. The inorganic slurry of claim 22, wherein the metal hydroxides comprise one or more of Al(OH)₃ and Mg(OH)₂.

28. The inorganic slurry of claim 22, wherein the metal carbonates comprise CaCO₃.
